(19) United States
(12) Patent Application Publication
(10) Pub. No.: US 2018/0329415 A1
(43) Pub. Date: Nov. 15, 2018

(54) DRIVER MONITORING APPARATUS AND DRIVER MONITORING METHOD

(71) Applicant: OMRON Corporation, Kyoto-shi (JP)

(72) Inventors: Hatsumi AOI, Kyotanabe-shi (JP); Kazuyoshi OKAJI, Omihachiman-shi (JP); Hiroshi Sugahara, Kyoto-shi (JP); Michie Uno, Kyoto-shi (JP); Koji Takizawa, Kyoto-shi (JP)

(73) Assignee: OMRON Corporation, Kyoto-shi (JP)

(21) Appl. No.: 15/951,478

(22) Filed: Apr. 12, 2018

(30) Foreign Application Priority Data
May 9, 2017 (JP) 2017-092845

(51) Int. Cl. G05D 1/00; B60W 40/09; B60W 30/182; B60W 50/14; G06K 9/00

(52) U.S. Cl. CPC G05D 1/0061; B60W 40/09; B60W 2040/0872; B60W 50/14; G06K 9/00845; B60W 30/182

(57) ABSTRACT

A driver monitoring apparatus includes: a biosensor signal acquiring portion configured to acquire a biosensor signal detected by a biosensor provided in a steering wheel, a biosensor signal storage portion configured to store first biological information acquired by the biosensor signal acquiring portion during the manual driving mode; a first determination processing portion configured to determine whether or not a driver who is to drive during the manual driving mode is gripping the steering wheel, based on second biological information acquired by the biosensor signal acquiring portion and the first biological information read out from the biosensor signal storage portion, if the autonomous driving mode is switched to the manual driving mode, and a first signal output portion configured to output a predetermined signal that is based on the result of the determination performed by the first determination processing portion.

### CROSS-REFERENCES TO RELATED APPLICATIONS

This application claims priority to Japanese Patent Application No. 2017-092845 filed May 9, 2017, the entire contents of which are incorporated herein by reference.

### FIELD

The disclosure relates to a driver monitoring apparatus and a driver monitoring method, and relates more particularly to a driver monitoring apparatus and a driver monitoring method for monitoring a driver of a vehicle that is provided with an autonomous driving mode and a manual driving mode.

### BACKGROUND

In recent years, research and development have been actively conducted to realize autonomous driving, i.e. autonomously controlling traveling of a vehicle. Autonomous driving technology is classified into several levels, ranging from a level at which at least part of traveling control, which includes acceleration and deceleration, steering, and braking, is automated, to a level of complete automation.

At an automation level at which vehicle operations and peripheral monitoring are performed by an autonomous driving system (e.g. level 3 at which acceleration, steering, and braking are entirely performed by the autonomous driving system, and a driver performs control when requested by the autonomous driving system), a situation is envisioned where an autonomous driving mode is switched to a manual driving mode in which the driver drives the vehicle, depending on factors such as the traffic environment. It is, for example, a situation where, although autonomous driving is possible on an expressway, the autonomous driving system requests the driver to manually drive the vehicle near an interchange.

In the autonomous driving mode at the aforementioned level 3, the driver is basically relieved from performing driving operations, and accordingly, the driver may perform an operation other than driving or may be less vigilant during autonomous driving. For this reason, when the autonomous driving mode is switched to the manual driving mode, the driver needs to be in a state of being able to take over the steering wheel operation and pedaling operation of the vehicle from the autonomous driving system, in order to ensure safety of the vehicle. A state where the driver can take over those operations from the autonomous driving system refers to, for example, a state where the driver is gripping a steering wheel.

As for a configuration for detecting a steering wheel operation performed by a driver, for example, a gripped state of a steering wheel is considered to be detectable when the autonomous driving mode is switched to the manual driving mode, by using a gripping-detection device disclosed in Patent Document 1 below.

However, with the gripping-detection device described in Patent Document 1, it cannot be accurately determined whether or not a hand that is in contact with the steering wheel is actually a driver's hand. For example, it will be determined that the driver is gripping the steering wheel even if a passenger other than the driver (a person in a passenger seat or a rear seat) other than the driver is gripping the steering wheel.

In the case of using the aforementioned gripping-detection device, when the autonomous driving mode is switched to the manual driving mode, there is concern that the driving mode will switch to autonomous driving even if a passenger other than the driver is gripping the steering wheel.

JP 2016-203660 is an example of background art.

### SUMMARY

One or more aspects have been made in view of the foregoing problem, and aims to provide a driver monitoring apparatus and a driver monitoring method with which, if the autonomous driving mode is switched to the manual driving mode, whether or not the original driver who is to drive during manual driving is gripping the steering wheel can be accurately detected.

To achieve the above-stated object, a driver monitoring apparatus (1) according to one or more aspects is a driver monitoring apparatus that monitors a driver sitting in a driver seat in a vehicle provided with an autonomous driving mode and a manual driving mode, the apparatus including:

a biological information acquiring portion configured to acquire biological information detected by a biological information detecting portion provided in a steering wheel of the vehicle;

a biological information storage portion configured to store first biological information acquired by the biological information acquiring portion during the manual driving mode;

a first determination processing portion configured to determine whether or not the driver who is to drive during the manual driving mode is gripping the steering wheel, based on second biological information acquired by the biological information acquiring portion and the first biological information read out from the biological information storage portion, if the autonomous driving mode is to be switched to the manual driving mode; and

a first signal output portion configured to output a predetermined signal that is based on a result of the determination performed by the first determination processing portion.

With the above-described driver monitoring apparatus (1), if the autonomous driving mode is switched to the manual driving mode, whether or not the driver who is to drive during the manual driving mode is gripping the steering wheel is determined based on the second biological information acquired by the biological information acquiring portion and the first biological information read out from the biological information storage portion, and the predetermined signal that is based on the result of the determination is output.

Accordingly, by using the second biological information and the first biological information, if the autonomous driving mode is switched to the manual driving mode, whether or not the original driver who is to drive during manual driving is gripping the steering wheel can be accurately detected.

In addition, an external device can be caused to efficiently and promptly execute the predetermined processing based on the predetermined signal, by outputting the predetermined signal that is based on the result of the determination performed by the first determination processing portion. Thus, the safety of the vehicle can be enhanced when the autonomous driving mode is switched to the manual driving mode.

A driver monitoring apparatus (2) according to one or more aspects is the above-described driver monitoring apparatus (1), further including:

an image acquiring portion configured to acquire a driver image captured by an image capturing portion for capturing an image of the driver; and

an image storage portion configured to store a first driver image acquired by the image acquiring portion during the manual driving mode,

wherein the driver monitoring apparatus comprises, in place of the first determination processing portion and the first signal output portion:

a second determination processing portion configured to determine whether or not the driver who is to drive during the manual driving mode is gripping the steering wheel, based on the second biological information acquired by the biological information acquiring portion, the first biological information read out from the biological information storage portion, a second driver image acquired by the image acquiring portion, and the first driver image read out from the image storage portion, if the autonomous driving mode is to be switched to the manual driving mode; and

a second signal output portion configured to output a predetermined signal that is based on a result of the determination performed by the second determination processing portion.

With the above-described driver monitoring apparatus (2), if the autonomous driving mode is switched to the manual driving mode, whether or not the driver who is to drive during the manual driving mode is gripping the steering wheel is determined based on the second biological information acquired by the biological information acquiring portion, the first biological information read out from the biological information storage portion, the second driver image acquired by the image acquiring portion, and the first driver image read out from the image storage portion. Then, the predetermined signal that is based on the result of this determination is output.

Accordingly, by using the second driver image and the first driver image in addition to the second biological information and the first biological information, if the autonomous driving mode is to be switched to the manual driving mode, whether or not the original driver who is to drive during manual driving is gripping the steering wheel can be further accurately detected.

In addition, an external device can be caused to efficiently and promptly execute the predetermined processing based on the predetermined signal, by outputting the predetermined signal that is based on the result of the determination performed by the second determination processing portion. Thus, the safety of the vehicle can be enhanced when the autonomous driving mode is switched to the manual driving mode.

A driver monitoring apparatus (3) according to one or more aspects is the above-described driver monitoring apparatus (2), further including:

a third determination processing portion configured to determine whether or not the driver during the autonomous driving mode matches the driver who is to drive during the manual driving mode, based on a third driver image acquired by the image acquiring portion during the autonomous driving mode, and the first driver image read out from the image storage portion; and

a third signal output portion configured to output a predetermined signal that is based on a result of the determination performed by the third determination processing portion.

With the above-described driver monitoring apparatus (3), whether or not the driver during the autonomous driving mode matches the driver who is to drive during the manual driving mode is determined by using the third driver image acquired by the image acquiring portion in the autonomous driving mode, and the first driver image read out from the image storage portion. Then, the predetermined signal that is based on the result of this determination is output.

Accordingly, it is possible to detect whether or not the driver, i.e. a person who operates the steering wheel and sits in the driver seat has changed to a different driver, after the manual driving mode has been switched to the autonomous driving mode (i.e. during the autonomous driving mode). For example, if the driver changes to a different driver during the manual driving mode, it is difficult for the driver to promptly take over driving operations when the autonomous driving mode is switched to the manual driving mode. However, with the above-described driver monitoring apparatus (3), changing of the driver during the autonomous driving mode can be prevented, and it is possible to enable the driver to smoothly take over driving operations when the autonomous driving mode is switched to the manual driving mode.

A driver monitoring apparatus (4) according to one or more aspects is the above-described driver monitoring apparatus (1), in which, if it is determined by the first determination processing portion that the driver who is to drive during the manual driving mode is gripping the steering wheel, the first signal output portion outputs a signal for permitting switching from the autonomous driving mode to the manual driving mode, to an autonomous driving control portion that performs control in the autonomous driving mode.

With the above-described driver monitoring apparatus (4), if it is determined that the driver who is to drive during the manual driving mode is gripping the steering wheel, a signal for permitting switching from the autonomous driving mode to the manual driving mode is output to the autonomous driving control portion. Accordingly, the autonomous driving mode is switched to the manual driving mode after the driver has taken over steering wheel operations, and the safety of the vehicle after this switching can be ensured.

A driver monitoring apparatus (5) according to one or more aspects is the above-described driver monitoring apparatus (1), in which, if it is determined by the first determination processing portion that the driver who is to drive during the manual driving mode is not gripping the steering wheel, the first signal output portion outputs, to a warning portion provided in the vehicle, a signal for causing the warning portion to execute predetermined warning processing.

With the above-described driver monitoring apparatus (5), if it is determined that the driver who is to drive during the manual driving mode is not gripping the steering wheel, a signal for causing the warning portion to execute predetermined warning processing is output. Accordingly, it is possible to warn the driver who is to drive during the manual driving mode to take over steering wheel operations.

A driver monitoring apparatus (6) according to one or more aspects is the above-described driver monitoring apparatus (1), in which, if it is determined by the first determination processing portion that the driver who is to drive during the manual driving mode is not gripping the steering wheel, the first signal output portion outputs a signal for giving an instruction to stop the vehicle through autonomous driving, to an autonomous driving control portion that performs control in the autonomous driving mode.

With the above-described driver monitoring apparatus (6), if it is determined that the driver who is to drive during the manual driving mode is not gripping the steering wheel, a signal for instructing the autonomous driving control portion to stop the vehicle through autonomous driving is output thereto. Accordingly, if the autonomous driving mode is to be switched to the manual driving mode, when the driver who is to drive during the manual driving mode is not gripping the steering wheel, the vehicle can be stopped by the autonomous driving control portion, and the safety of the vehicle can be ensured.

A driver monitoring apparatus (7) according to one or more aspects is the above-described driver monitoring apparatus (2) or (3), in which, if it is determined by the second determination processing portion that the driver who is to drive during the manual driving mode is gripping the steering wheel, the second signal output portion outputs a signal for permitting switching from the autonomous driving mode to the manual driving mode, to an autonomous driving control portion that performs control in the autonomous driving mode.

With the above-described driver monitoring apparatus (7), substantially the same effects as those of the above-described driver monitoring apparatus (4) can be obtained.

A driver monitoring apparatus (8) according to one or more aspects is the above-described driver monitoring apparatus (2) or (3), in which, if it is determined by the second determination processing portion that the driver who is to drive during the manual driving mode is not gripping the steering wheel, the second signal output portion outputs, to a warning portion provided in the vehicle, a signal for causing the warning portion to execute predetermined warning processing.

With the above-described driver monitoring apparatus (8), substantially the same effects as those of the above-described driver monitoring apparatus (5) can be obtained.

A driver monitoring apparatus (9) according to one or more aspects is the above-described driver monitoring apparatus (2) or (3), in which, if it is determined by the second determination processing portion that the driver who is to drive during the manual driving mode is not gripping the steering wheel, the second signal output portion outputs a signal for giving an instruction to stop the vehicle through autonomous driving, to an autonomous driving control portion that performs control in the autonomous driving mode.

With the above-described driver monitoring apparatus (9), substantially the same effects as those of the above-described driver monitoring apparatus (6) can be obtained.

A driver monitoring method according to one or more aspects is a driver monitoring method for monitoring a driver sitting in a driver seat in a vehicle provided with an autonomous driving mode and a manual driving mode, by using an apparatus including a storage portion and a hardware processor connected to the storage portion,

the storage portion including a biological information storage portion configured to store biological information detected by a biological information detecting portion provided in a steering wheel of the vehicle,

the method including:

acquiring first biological information detected by the biological information detecting portion during the manual driving mode, by the hardware processor;

causing the biological information storage portion to store the acquired first biological information, by the hardware processor;

acquiring second biological information detected by the biological information detecting portion, by the hardware processor, if the autonomous driving mode is to be switched to the manual driving mode;

reading out the first biological information from the biological information storage portion, by the hardware processor;

determining whether or not the driver who is to drive during the manual driving mode is gripping the steering wheel, based on the second biological information and the first biological information, by the hardware processor; and

outputting a predetermined signal that is based on a result of the determination, by the hardware processor.

With the above-described driver monitoring method, if the autonomous driving mode is to be switched to the manual driving mode, whether or not the driver who drives during the manual driving mode is gripping the steering wheel is determined by the hardware processor, based on the second biological information acquired from the biological information detecting portion and the first biological information read out from the biological information storage portion, and the predetermined signal that is based on the result of this determination is output. Accordingly, by using the second biological information and the first biological information, if the autonomous driving mode is to be switched to the manual driving mode, whether or not the original driver who is to drive during manual driving is gripping the steering wheel can be accurately detected.

In addition, an external device can be caused to efficiently and promptly execute the predetermined processing based on the predetermined signal, by outputting the predetermined signal that is based on the result of this determination. Thus, the safety of the vehicle can be enhanced when the autonomous driving mode is switched to the manual driving mode.

### BRIEF DESCRIPTION OF THE DRAWINGS

FIG. 1 is a block diagram illustrating a configuration of essential parts of an autonomous driving system that includes a driver monitoring apparatus according to Embodiment (1).

FIG. 2 is a front elevational view illustrating a steering wheel, showing an example of a position at which biosensors are installed.

FIG. 3 is a block diagram illustrating a hardware configuration of a driver monitoring apparatus according to Embodiment (1).

FIG. 4 is a flowchart illustrating a processing operation performed by a control unit in a driver monitoring apparatus according to Embodiment (1).

FIG. 5 is a flowchart illustrating a processing operation performed by a control unit in a driver monitoring apparatus according to Embodiment (1).

FIG. 6 is a block diagram illustrating a configuration of essential parts of an autonomous driving system that includes a driver monitoring apparatus according to Embodiment (2).

FIG. 7 is a block diagram illustrating a hardware configuration of a driver monitoring apparatus according to Embodiment (2).

FIG. 8 is a flowchart illustrating a processing operation performed by a control unit in a driver monitoring apparatus according to Embodiment (2).

FIG. 9 is a flowchart illustrating a processing operation performed by a control unit in a driver monitoring apparatus according to Embodiment (2).

### DETAILED DESCRIPTION

Hereinafter, embodiments of a driver monitoring apparatus and a driver monitoring method will be described based on the drawings. Note that the following embodiments are preferable specific examples and are technically limited in various ways. However, the scope of the present invention is not limited to these embodiments unless it is particularly stated in the following description that the present invention is limited.

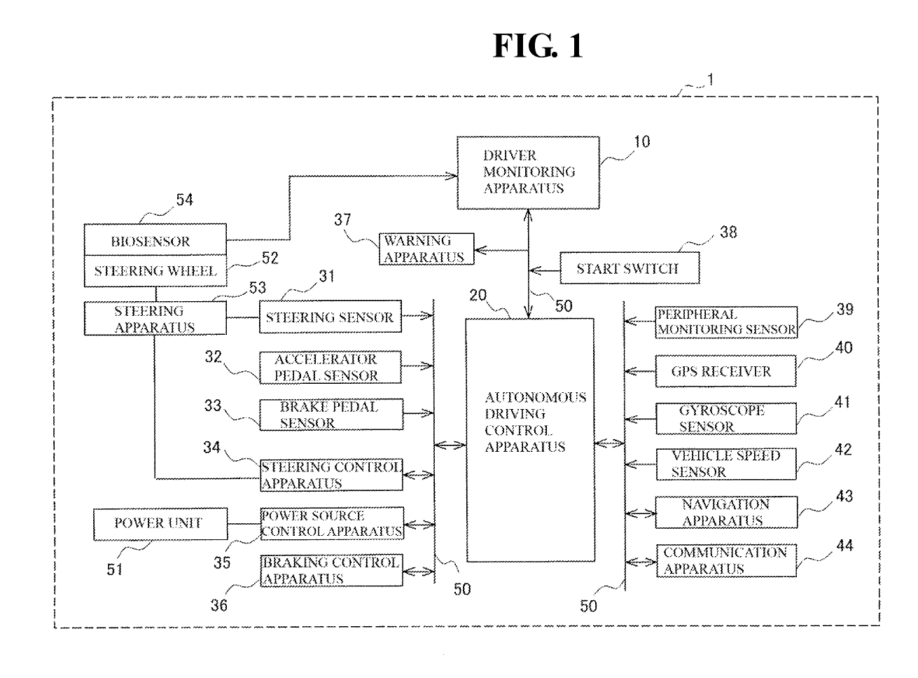

FIG. 1 is a block diagram showing a configuration of essential parts of an autonomous driving system that includes a driver monitoring apparatus according to Embodiment (1).

An autonomous driving system 1 includes a driver monitoring apparatus 10 and an autonomous driving control apparatus 20. The autonomous driving control apparatus 20 has a configuration for switching between an autonomous driving mode, in which at least part of traveling control that includes acceleration and deceleration, steering, and braking of a vehicle is autonomously performed by the system, and a manual driving mode, in which a driver performs driving operations. In Embodiment (1), the driver refers to a person who sits in the driver seat in a vehicle.

In addition to the driver monitoring apparatus 10 and the autonomous driving control apparatus 20, the autonomous driving system 1 includes sensors, control apparatuses, and the like that are required for various kinds of control in autonomous driving and manual driving, such as a steering sensor 31, an accelerator pedal sensor 32, a brake pedal sensor 33, a steering control apparatus 34, a power source control apparatus 35, a braking control apparatus 36, a warning apparatus 37, a start switch 38, a peripheral monitoring sensor 39, a GPS receiver 40, a gyroscope sensor 41, a vehicle speed sensor 42, a navigation apparatus 43, and a communication apparatus 44. These various sensors and control apparatuses are connected to one another via a communication line 50.

The vehicle is also equipped with a power unit 51, which includes power sources such as an engine and a motor, and a steering apparatus 53 that includes a steering wheel 52, which is steered by the driver. A biosensor 54 is provided in the steering wheel 52. A hardware configuration of the driver monitoring apparatus 10 will be described later.

The autonomous driving control apparatus 20 is an apparatus that executes various kinds of control associated with autonomous driving of the vehicle, and is constituted by an electronic control unit that includes a control portion, a storage portion, an input portion, an output portion, and the like, which are not shown in the diagrams. The control portion includes one or more hardware processors, reads out a program stored in the storage portion, and executes various kinds of vehicle control.

The autonomous driving control apparatus 20 is not only connected to the driver monitoring apparatus 10 but also to the steering sensor 31, the accelerator pedal sensor 32, the brake pedal sensor 33, the steering control apparatus 34, the power source control apparatus 35, the braking control apparatus 36, the peripheral monitoring sensor 39, the GPS receiver 40, the gyroscope sensor 41, the vehicle speed sensor 42, the navigation apparatus 43, the communication apparatus 44, and so on. Based on information acquired from these portions, the autonomous driving control apparatus 20 outputs control signals for performing autonomous driving to the control apparatuses, and performs autonomous traveling control (autonomous steering control, autonomous speed adjustment control, autonomous braking control etc.) of the vehicle.

Autonomous driving refers to allowing a vehicle to autonomously travel on a road under the control performed by the autonomous driving control apparatus 20, without a driver sitting in the driver seat and performing driving operations. For example, autonomous driving includes a driving state in which the vehicle is allowed to autonomously travel in accordance with a preset route to a destination, a travel route that is automatically generated based on a situation outside the vehicle and map information, or the like. The autonomous driving control apparatus 20 ends (cancels) autonomous driving if predetermined conditions for canceling autonomous driving are satisfied. For example, the autonomous driving control apparatus 20 ends autonomous driving if it is determined that the vehicle that is subjected to autonomous driving has arrived at a predetermined end point of autonomous driving. The autonomous driving control apparatus 20 may also perform control to end autonomous driving if the driver performs an autonomous driving canceling operation (e.g. an operation to an autonomous driving cancel button, an operation to a steering wheel, an accelerator, or a brake made by the driver etc.). Manual driving refers to driving in which the driver performs driving operations to cause the vehicle to travel.

The steering sensor 31 is a sensor for detecting the amount of steering performed with the steering wheel 52 that is provided on the front side of the driver seat. The steering sensor 31 is provided on, for example, a steering shaft of the vehicle, and detects the steering torque applied to the steering wheel 52 by the driver or the steering angle of the steering wheel 52. A signal that corresponds to a steering wheel operation performed by the driver detected by the steering sensor 31 is output to the autonomous driving control apparatus 20 and the steering control apparatus 34.

The accelerator pedal sensor 32 is a sensor for detecting the amount by which an accelerator pedal (position of the accelerator pedal) is pressed with a foot, and is provided on, for example, a shaft portion of the accelerator pedal. A signal that corresponds to the amount by which the accelerator pedal is pressed with a foot detected by the accelerator pedal sensor 32 is output to the autonomous driving control apparatus 20 and the power source control apparatus 35.

The brake pedal sensor 33 is a sensor for detecting the amount by which the brake pedal is pressed with a foot (position of the brake pedal) or the operational force (foot pressing force etc.) applied thereon. A signal that corresponds to the amount by which the brake pedal is pressed with a foot or the operational force detected by the brake pedal sensor 33 is output to the autonomous driving control apparatus 20 and the braking control apparatus 36.

The steering control apparatus 34 is an electronic control unit for controlling the steering apparatus (e.g. electric power steering device) 53 of the vehicle. The steering control apparatus 34 controls the steering torque of the vehicle by driving a motor for controlling the steering torque of the vehicle. In the autonomous driving mode, the steering torque is controlled in accordance with a control signal from the autonomous driving control apparatus 20.

The power source control apparatus 35 is an electronic control unit for controlling the power unit 51. The power source control apparatus 35 controls the driving force of the vehicle by controlling, for example, the amounts of fuel and air supplied to the engine, or the amount of electricity supplied to the motor. In the autonomous driving mode, the driving force of the vehicle is controlled in accordance with a control signal from the autonomous driving control apparatus 20.

The braking control apparatus 36 is an electronic control unit for controlling a brake system of the vehicle. The braking control apparatus 36 controls the braking force applied to wheels of the vehicle by adjusting the hydraulic pressure applied to a hydraulic pressure brake system, for example. In the autonomous driving mode, the braking force applied to the wheels is controlled in accordance with a control signal from the autonomous driving control apparatus 20.

The warning apparatus 37 is configured to include an audio output portion for outputting various warnings and directions in the form of sound or voice, a display output portion for displaying various warnings and directions in the form of characters or diagrams, or by lighting a lamp, and so on (all these portions not shown in the diagrams). The warning apparatus 37 operates based on warning instruction signals output from the driver monitoring apparatus 10 and the autonomous driving control apparatus 20.

The start switch 38 is a switch for starting and stopping the power unit 51, and is constituted by an ignition switch for starting the engine, a power switch for starting a traveling motor, and so on. An operation signal from the start switch 38 is input to the driver monitoring apparatus 10 and the autonomous driving control apparatus 20.

The peripheral monitoring sensor 39 is a sensor for detecting a target object that is present around the vehicle. The target object may be, for example, a moving object such as a car, a bicycle, or a person, a marker on a road surface (white line etc.), a guard rail, a median strip, or other structures that may affect travel of the vehicle. The peripheral monitoring sensor 39 includes at least one of a front monitoring camera, a rear monitoring camera, a radar, a LIDER, i.e. a Light Detection and Ranging or Laser Imaging Detection and Ranging, and an ultrasonic sensor. Detection data, i.e. data on a target object detected by the peripheral monitoring sensor 39 is output to the autonomous driving control apparatus 20 and so on. A stereo camera, a monocular camera, or the like may be employed as the front monitoring camera and the rear monitoring camera. The radar detects the position, direction, distance, and the like of a target object by transmitting radio waves, such as millimeter waves, to the periphery of the vehicle, and receiving radio waves reflected off a target object that is present around the vehicle. The LIDER detects the position, direction, distance, and the like of a target object by transmitting a laser beam to the periphery of the vehicle and receiving a light beam reflected off a target object that is present around the vehicle.

The GPS receiver 40 is an apparatus that performs processing (GPS navigation) to receive a GPS signal from an artificial satellite via an antenna (not shown) and identify the vehicle position based on the received GPS signal. Information regarding the vehicle position identified by the GPS receiver 40 is output to the autonomous driving control apparatus 20, the navigation apparatus 43, and so on.

The gyroscope sensor 41 is a sensor for detecting the rotational angular speed (yaw rate) of the vehicle. A rotational angular speed signal detected by the gyroscope sensor 41 is output to the autonomous driving control apparatus 20, the navigation apparatus 43, and so on.

The vehicle speed sensor 42 is a sensor for detecting the vehicle speed, and is constituted by, for example, a wheel speed sensor that is provided on a wheel, a drive shaft, or the like, and detects the rotational speed of the vehicle. The vehicle speed signal detected by the vehicle speed sensor 42 is output to the autonomous driving control apparatus 20, the navigation apparatus 43, and so on.

Based on information regarding the vehicle position measured by the GPS receiver 40 or the like, and map information in a map database (not shown), the navigation apparatus 43 identifies the road and traffic lane on which the vehicle is traveling, calculates a route from the current vehicle position to a destination and the like, displays this route on a display portion (not shown), and provides audio output for route guidance or the like from an audio output portion (not shown). The vehicle position information, information regarding the road being traveled, scheduled traveling route information, and the like that are obtained by the navigation apparatus 43 are output to the autonomous driving control apparatus 20. The scheduled traveling route information also includes information associated with autonomous driving switching control, such as a start point and an end point of an autonomous driving zone, and an autonomous driving start notification point and an autonomous driving end (cancellation) notification point. The navigation apparatus 43 is configured to include a control portion, a display portion, an audio output portion, an operation portion, and a map data storage portion, and so on, which are not shown in the diagrams.

The communication apparatus 44 is an apparatus for acquiring various kinds of information via a wireless communication network (e.g. a communication network such as a cellular phone network, VICS (registered trademark), or DSRC (registered trademark). The communication apparatus 44 may also include an inter-vehicle communication function or a road-vehicle communication function. For example, road environment information regarding a course of the vehicle (traffic lane restriction information etc.) can be acquired through road-vehicle communication with a road-side transceiver (e.g. light beacon, ITS spot (registered trademark)) or the like that is provided on a road side. Also, information regarding other vehicles (position information, information regarding traveling control etc.), road environment information detected by other vehicles, and so on can be acquired through inter-vehicle communication.

A biosensor 54 (biological information detecting portion) provided in the steering wheel 52 is a sensor that detects biological information with which an individual can be identified with a hand (particularly, parts such as a palm and a finger) that comes into contact with the steering wheel 52. For example, the biosensor 54 may be at least one of a fingerprint detection sensor that detects a fingerprint of a hand (including a finger) that comes into contact with the steering wheel 52, a pulse detection sensor that detects a pulse from the hand, a vein pattern detection sensor that detects a vein pattern of the hand, and a palm print pattern detection sensor that detects a palm print pattern of the hand, but is not limited thereto. Two or more of these sensors may also be combined for use.

The fingerprint detection sensor may be an optical sensor or a non-optical sensor. An optical sensor is a sensor that radiates light to a hand (finger) and detects a fingerprint based on gradation data of ridges and valleys of a fingerprint, using a principle that light reflects in different ways at ridges and valleys. A non-optical sensor is a sensor that detects a fingerprint by electrically detecting, using a semiconductor sensor or the like, capacitance or a temperature difference that occurs due to an uneven surface formed by ridges and valleys of a fingerprint.

The vein pattern detection sensor may be, for example, a sensor that detects the intensity of reflection of a near infrared beam generated by a light-emitting device to recognize a vein shape.

The pulse detection sensor may be, for example, a sensor that uses a light source for emitting an infrared beam or a visible beam and infrared beam, and a photodiode, detects reflection light obtained by applying the light source to a fingertip, and detects a change in the amount of transmitted light as a pulse wave.

The palm print pattern detection sensor may be, for example, a palm print authentication sensor that extracts feature lines of a palm print portion or a finger joint portion from a palm image, which is captured by an image sensor, and performs matching of these feature lines.

The position on the steering wheel 52 at which the biosensor 54 is installed and the number of biosensors 54 to be installed are not particularly limited. The biosensors 54 may also be provided over the entire circumference of the steering wheel 52.

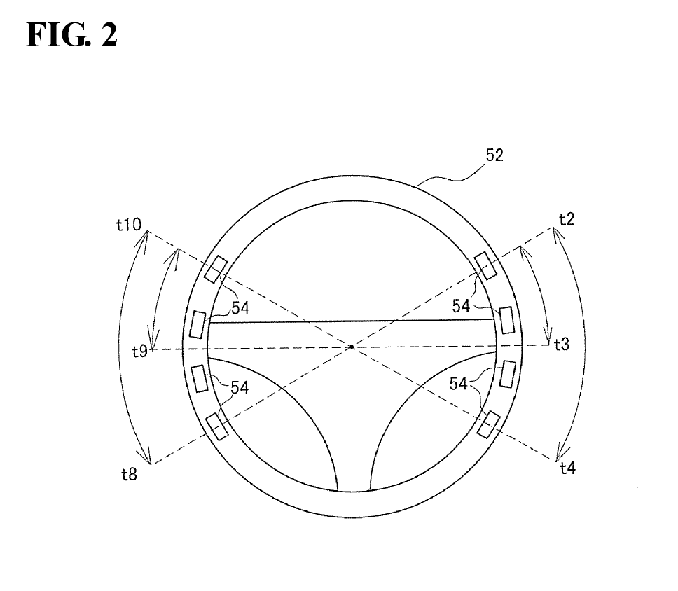

FIG. 2 is a front elevational view of the steering wheel 52, showing an example of the positions at which the biosensors 54 are installed. To enable detection of the driver correctly gripping the steering wheel 52 with both hands, it is favorable to install at least one or more pairs of left and right biosensors 54 respectively in a range from two o'clock (t2) to three o'clock (t3) and in a range from nine o'clock (t9) to ten o'clock (t10) of an analog clock. Alternatively, to enable detection of the steering wheel 52 appropriately gripped on both left and right sides, one or more pairs of left and right biosensors 54 may also be installed respectively in a range from two o'clock (t2) to four o'clock (t4) and in a range from eight o'clock (t8) to ten o'clock (t10) of an analog watch.

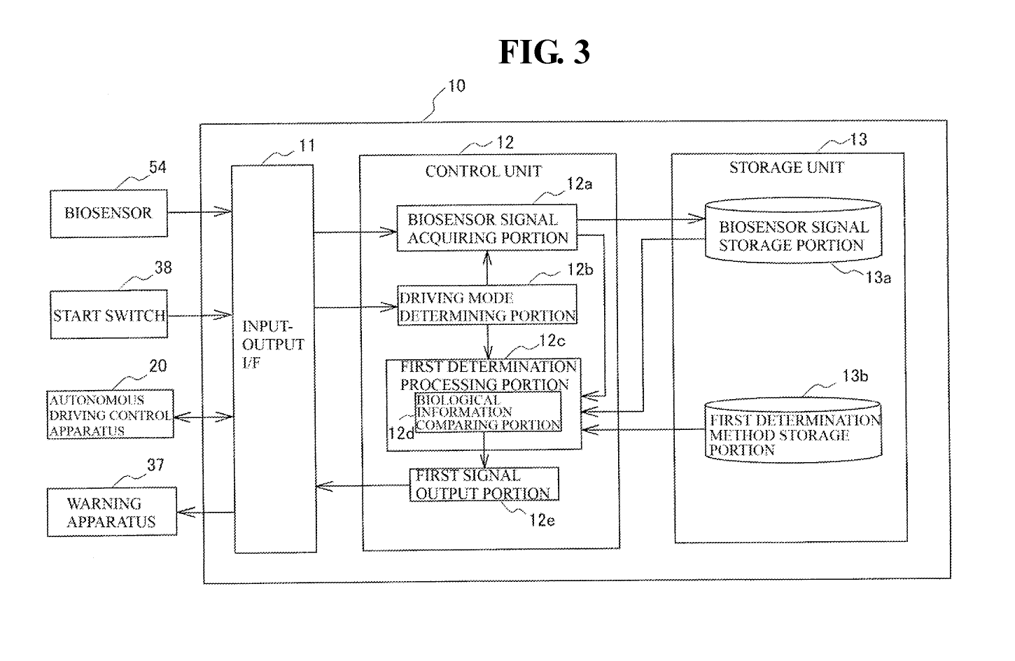

A hardware configuration of the driver monitoring apparatus 10 according to Embodiment (1) will now be described based on the block diagram shown in FIG. 3.

The driver monitoring apparatus 10 is configured to include an input-output interface (I/F) 11, a control unit 12, and a storage unit 13.

The input-output I/F 11 is connected to the biosensor 54, the start switch 38, the autonomous driving control apparatus 20, the warning apparatus 37, and so on, and is configured to include circuits, connectors, and the like for exchanging signals with these external devices.

The control unit 12 is configured to include a biosensor signal acquiring portion 12a (biological information acquiring portion), a driving mode determining portion 12b, a first determination processing portion 12c, and a first signal output portion 12e, and is configured to include one or more hardware processors such as a central processing unit (CPU).

The storage unit 13 is configured to include a biosensor signal storage portion 13a (biological information storage portion), and a first determination method storage portion 13b, and is configured to include one or more memory devices for storing data using semiconductor devices, such as a read only memory (ROM), a random access memory (RAM), a solid-state drive (SSD), a hard disk drive (HDD), a flash memory, and other nonvolatile memories, and volatile memories.

The control unit 12 is configured to cooperate with the storage unit 13 to perform processing to store acquired data in the storage unit 13, as well as read out data and programs stored in the storage unit 13 and executes these programs.

The driving mode determining portion 12b, which is included in the control unit 12, executes, for example, processing to determine the driving mode, which may be the autonomous driving mode or the manual driving mode, based on an autonomous driving mode setting signal, an autonomous driving mode cancel notification signal, an autonomous driving mode cancel signal, and so on, which are acquired from the autonomous driving control apparatus 20. The autonomous driving mode setting signal is a signal that is output after the setting of (switching to) the autonomous driving mode has been completed. The autonomous driving mode cancel notification signal is a signal that is output before the autonomous driving mode is switched to the manual driving mode (e.g. if a manual driving operation takeover zone is entered). The autonomous driving mode cancel signal is a signal that is output after the autonomous driving mode has been canceled and switched to the manual driving mode.

The biosensor signal acquiring portion 12a executes processing to acquire a biosensor signal from the biosensor 54 if it is determined by the driving mode determining portion 12b that the current driving mode is the manual driving mode, and executes processing to store the acquired biosensor signal as a biosensor signal (first biological information) obtained during the manual driving mode, in the biosensor signal storage portion 13a.

Also, if an autonomous driving mode cancel notification (notification of switching from the autonomous driving mode to the manual driving mode) is detected by the driving mode determining portion 12b, the biosensor signal acquiring portion 12a executes processing to acquire a biosensor signal (second biological information) from the biosensor 54, and sends the acquired biosensor signal to the first determination processing portion 12c.

The first determination processing portion 12c includes a biological information comparing portion 12d. If an autonomous driving mode cancel notification is detected by the driving mode determining portion 12b, the biological information comparing portion 12d performs processing to read out the biosensor signal obtained during the manual driving mode from the biosensor signal storage portion 13a, and compare the read biosensor signal (first biological information) obtained during the manual driving mode with the biosensor signal (second biological information) acquired from the biosensor 54 after the autonomous driving mode cancel notification has been detected.

The first signal output portion 12e outputs a signal that is based on the result of the determination performed by the biological information comparing portion 12d. For example, if the comparison result from the biological information comparing portion 12d indicates a match, the first signal output portion 12e outputs a signal for permitting switching from the autonomous driving mode to the manual driving mode to the autonomous driving control apparatus 20. On the other hand, if the comparison result indicates a mismatch, the first signal output portion 12e executes processing to output a signal for instructing the warning apparatus 37 to perform warning processing, or output a signal for giving a forcible danger avoidance instruction to force the vehicle to perform danger avoidance (stop or decelerate) through autonomous driving, to the autonomous driving control apparatus 20.

The biosensor signal storage portion 13a stores the biosensor signal (fingerprint information, pulse information, information regarding a vein pattern of a hand etc.) that is acquired by the biosensor signal acquiring portion 12a during the manual driving mode. The biosensor signal may also be stored in association with data such as acquisition time or the like.

The first determination method storage portion 13b stores a first determination processing program, which is to be executed by the first determination processing portion 12c in the control unit 12, data required to execute this program, and the like.

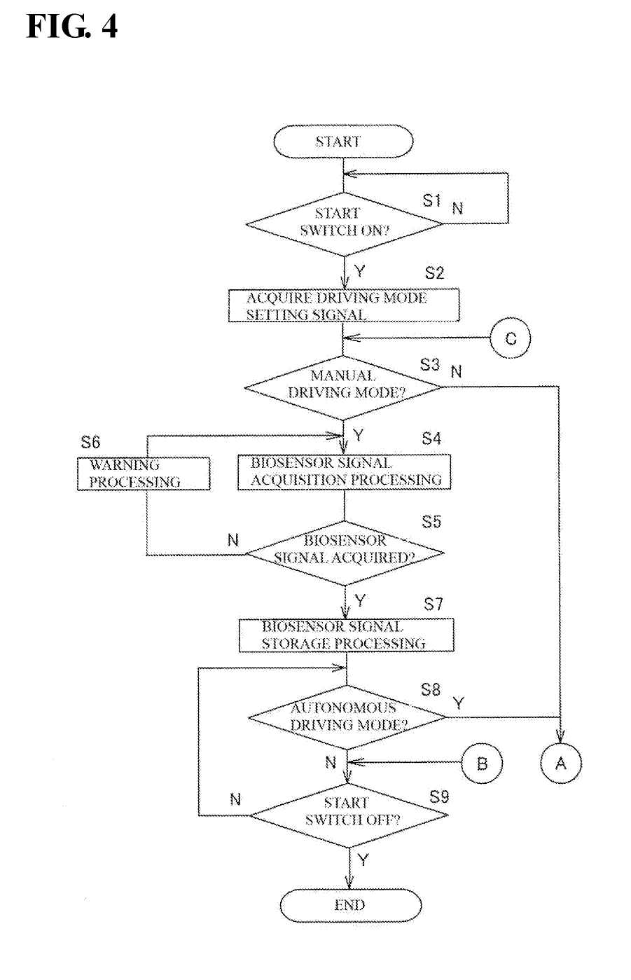

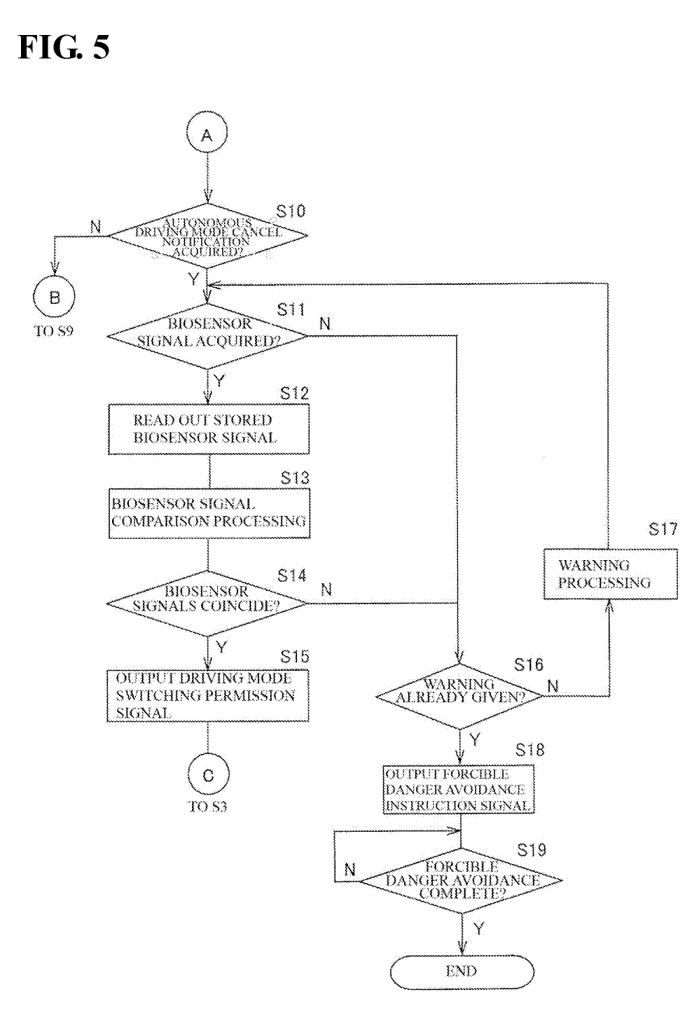

FIGS. 4 and 5 show a flowchart showing a processing operation performed by the control unit 12 in the driver monitoring apparatus 10 according to Embodiment (1).

Initially, in step S1, whether or not an ON signal from the start switch 38 has been acquired is determined. If it is determined that an ON signal from the start switch 38 has been acquired, the processing proceeds to step S2. In step S2, a driving mode setting signal for setting the autonomous driving mode or the manual driving mode is acquired from the autonomous driving control apparatus 20, and the processing then proceeds to step S3.

In step S3, whether or not the current driving mode is the manual driving mode is determined. If it is determined that the current driving mode is the manual driving mode, the processing proceeds to step S4. In step S4, processing is performed to acquire a biosensor signal (first biological information) detected by the biosensor 54, and the processing then proceeds to step S5.

In step S5, whether or not the biosensor signal (first biological information) has been acquired is determined. If it is determined that the biosensor signal has not been acquired, the processing proceeds to step S6. In step S6, a signal for instructing the warning apparatus 37 to output a warning to make the driver grip the steering wheel 52 is output, and the processing then returns to step S4. The warning apparatus 37 performs warning processing to make the driver grip the steering wheel 52, based on the warning output instruction signal from the driver monitoring apparatus 10.

On the other hand, if it is determined in step S5 that the biosensor signal has been acquired, the processing proceeds to step S7. In step S7, processing is performed to store the biosensor signal as the biosensor signal (first biological information) obtained during the manual driving mode in the biosensor signal storage portion 13a, and the processing then proceeds to step S8.

In step S8, whether or not a signal for setting (switching to) the autonomous driving mode has been acquired is determined. If it is determined that the signal has not been acquired, the processing proceeds to step S9. In step S9, whether or not an OFF signal from the start switch 38 has been acquired is determined. If it is determined that the OFF signal has been acquired, the processing then ends. On the other hand, if it is determined that the OFF signal has not been acquired, the processing returns to step S8.

On the other hand, if it is determined in step S3 that the current driving mode is not the manual driving mode, i.e. the current driving mode is the autonomous driving mode, or if it is determined in step S8 that the signal for setting the autonomous driving mode has been acquired, the processing proceeds to step S10 in FIG. 5.

In step S10, whether or not an autonomous driving mode cancel notification signal (signal indicating a notification of switching to the manual driving mode) has been acquired is determined. If it is determined that the autonomous driving mode cancel notification signal has been acquired, the processing then proceeds to step S11. In step S11, whether or not a biosensor signal (second biological information) has been acquired from the biosensor 54 is determined. Note that the autonomous driving mode cancel notification signal is a signal for giving the driver time to allow them to take over steering wheel operations and so on when the autonomous driving mode is canceled and switched to the manual driving mode, and is output from the autonomous driving control apparatus 20 to the driver monitoring apparatus 10 and the warning apparatus 37, for example. The warning apparatus 37 may perform, upon receiving the autonomous driving mode cancel notification signal, processing to notify the driver of the autonomous driving mode cancel notification.

If it is determined in step S11 that the biosensor signal has been acquired from the biosensor 54, the processing proceeds to step S12. In step S12, processing is performed to read out, from the biosensor signal storage portion 13a, the biosensor signal obtained during the manual driving mode. Thereafter, the processing proceeds to step S13. In step S13, processing is performed to compare the biosensor signal (second biological information) acquired after the autonomous driving mode cancel notification has been given with the biosensor signal (first biological information) obtained during the manual driving mode that is read out from the biosensor signal storage portion 13a. Thereafter, the processing proceeds to step S14.

In step S14, whether or not these biosensor signals coincide with each other is determined. If these biosensor signals coincide with each other, i.e. the driver at the time when the autonomous driving mode cancel notification was given (i.e. before the autonomous driving mode is switched to the manual driving mode) is the same as the driver who was driving during the manual driving mode (i.e. during the manual driving mode before being switched to the autonomous driving mode), that is, if it is determined that the driver who was driving during the manual driving mode is gripping the steering wheel 52 and is ready to drive, the processing proceeds to step S15. In step S15, processing is performed to output a signal for permitting switching of the driving mode from autonomous driving to manual driving to the autonomous driving control apparatus 20, and the processing then returns to step S3.

The autonomous driving control apparatus 20 cancels the autonomous driving mode based on the driving mode switching permission signal from the driver monitoring apparatus 10, and performs processing to transition to the manual driving mode.

On the other hand, if it is determined in step S11 that the biosensor signal has not been acquired from the biosensor 54, the processing proceeds to step S16. In step S16, whether or not a warning that the biosensor signal has not been acquired from the biosensor 54 has been given (i.e. a warning has already been given) is determined. If it is determined that the warning has not been given, the processing proceeds to step S17, a signal for instructing the warning apparatus 37 to output a warning for making the driver grip the steering wheel 52 is output, and the processing returns to step S11. The warning apparatus 37 performs warning processing to make the driver grip the steering wheel 52, based on the warning output instruction signal from the driver monitoring apparatus 10.

On the other hand, if it is determined in step S16 that the warning that the biosensor signal has not been acquired from the biosensor 54 has been given (i.e. the warning has already been given), the processing proceeds to step S18. In step S18, processing is performed to output a signal for giving a forcible danger avoidance instruction through autonomous driving to the autonomous driving control apparatus 20. The autonomous driving control apparatus 20 performs processing to stop the vehicle at a safe place through autonomous driving, based on the forcible danger avoidance instruction signal from the driver monitoring apparatus 10. Thereafter, in step S19, whether or not a forcible danger avoidance completion signal has been acquired from the autonomous driving control apparatus 20 is determined. If it is determined that the forcible danger avoidance completion signal has been acquired, the processing then ends.

If it is determined in step S14 that the biosensor signals do not coincide with each other, the processing proceeds to step S16. In step S16, whether or not a warning that the biosensor signals do not coincide with each other has been given (i.e. a warning has already been given) is determined. If it is determined that the warning has not been given, the processing proceeds to step S17. In step S17, a signal for instructing the warning apparatus 37 to output a warning to make the driver who was driving during the manual driving mode drive the vehicle is output, and the processing then returns to step S11. The warning apparatus 37 performs warning processing to make the driver who was driving during the manual driving mode drive the vehicle, based on the warning output instruction signal from the driver monitoring apparatus 10.

On the other hand, if it is determined in step S16 that the warning that the biosensor signals do not coincide with each other has been given (i.e. the warning has already been given), the processing proceeds to step S18. In step S18, processing is performed to output a signal for giving a forcible danger avoidance instruction through autonomous driving to the autonomous driving control apparatus 20. The autonomous driving control apparatus 20 performs processing to stop the vehicle at a safe place through autonomous driving, based on the forcible danger avoidance instruction signal from the driver monitoring apparatus 10. Thereafter, in step S19, whether or not a forcible danger avoidance completion signal has been acquired from the autonomous driving control apparatus 20 is determined. If it is determined that the forcible danger avoidance completion signal has been acquired, the processing then ends.

With the driver monitoring apparatus 10 according to Embodiment (1) described above, if the autonomous driving mode is switched to the manual driving mode (e.g. after the aforementioned autonomous driving mode cancel notification has been given), the biosensor signal (second biological information) acquired by the biosensor signal acquiring portion 12a is compared with the biosensor signal (first biological information) obtained during the manual driving mode that is read out from the biosensor signal storage portion 13a. Thus, whether or not the original driver who is to drive during manual driving is gripping the steering wheel 52 can be accurately determined. Furthermore, by outputting a predetermined signal that is based on the result of the determination performed by the first determination processing portion 12c, an external device such as the autonomous driving control apparatus 20 can be caused to efficiently and promptly execute predetermined processing that is based on this predetermined signal. Thus, the safety of the vehicle can be enhanced when the autonomous driving mode is switched to the manual driving mode.

If the control unit 12 determines that the driver who was driving during the manual driving mode is gripping the steering wheel 52, a signal for permitting switching from the autonomous driving mode to the manual driving mode is output to the autonomous driving control apparatus 20. Then, the autonomous driving mode is switched to the manual driving mode after the driver has taken over steering wheel operations, and the safety of the vehicle after this switching can be ensured.

If the control unit 12 determines that the driver who was driving during the manual driving mode is not gripping the steering wheel 52, a signal for causing the warning apparatus 37 to execute warning processing is output thereto. Accordingly, it is possible to warn the driver who was driving during the manual driving mode to take over operations of the steering wheel 52.

If the control unit 12 determines that the driver who was driving during the manual driving mode is not gripping the steering wheel 52 and also determines that a warning has already been given, a signal for instructing the autonomous driving control apparatus 20 to stop the vehicle through autonomous driving is output thereto. Accordingly, when the autonomous driving mode is switched to the manual driving mode, if the driver who was driving during the manual driving mode is not gripping (cannot grip) the steering wheel 52, the vehicle can be safely stopped under the control of the autonomous driving control apparatus 20.

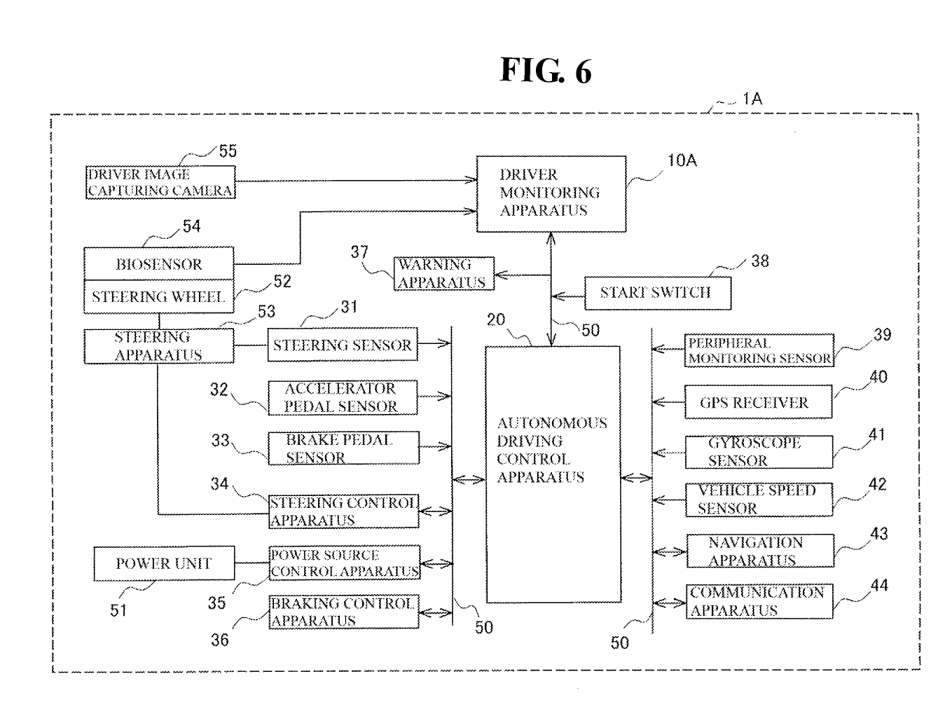

FIG. 6 is a block diagram showing a configuration of essential parts of an autonomous driving system 1A that includes a driver monitoring apparatus 10A according to Embodiment (2). Note that constituent parts that have the same functions as those of the essential parts of the autonomous driving system 1 shown in FIG. 1 are assigned the same numerals, and descriptions thereof are omitted here.

The autonomous driving system 1A is further equipped with a driver image capturing camera 55 for capturing an image that contains the face of the driver, and the driver monitoring apparatus 10A according to Embodiment (2) significantly differs from the driver monitoring apparatus 10 according to Embodiment (1) in that the driver monitoring apparatus 10A executes processing using a driver image captured by the driver image capturing camera 55.

The driver image capturing camera 55 is an apparatus (image capturing portion) for capturing an image that contains the face of the driver who is steering the steering wheel 52, and is configured to include an infrared camera portion (which includes an image sensor such as a CCD or a CMOS), an infrared light radiating portion (LED), an interface portion, a camera control portion for controlling each of these portion, and so on, so as to be able to capture an image of the driver state day and night, for example. The camera control portion controls the infrared camera portion and the infrared light radiating portion, infrared light (such as a near infrared beam) is radiated from the infrared light radiating portion, and an image of reflected light of the infrared light is captured by the infrared camera portion. Data of the image captured by the driver image capturing camera 55 is output to the driver monitoring apparatus 10A.

The number of driver image capturing cameras 55 may be one, or may also be two or more. The driver image capturing camera 55 may be configured separately (i.e. configured as a separate body) from the driver monitoring apparatus 10A, or may also be integrally configured (i.e. configured as an integrated body) with the driver monitoring apparatus 10A. The driver image capturing camera 55 may be a monocular camera, or may also be a stereo camera.

The position in a vehicle cabin at which the driver image capturing camera 55 is installed is not particularly limited as long as it is a position at which an image that contains the face of the driver can be captured. For example, the driver image capturing camera 55 can be installed in the steering wheel 52, a column portion of the steering wheel 52, a meter panel portion, on a dashboard, at a position near a rear-view mirror, or in an A pillar portion or the navigation apparatus 43, for example.

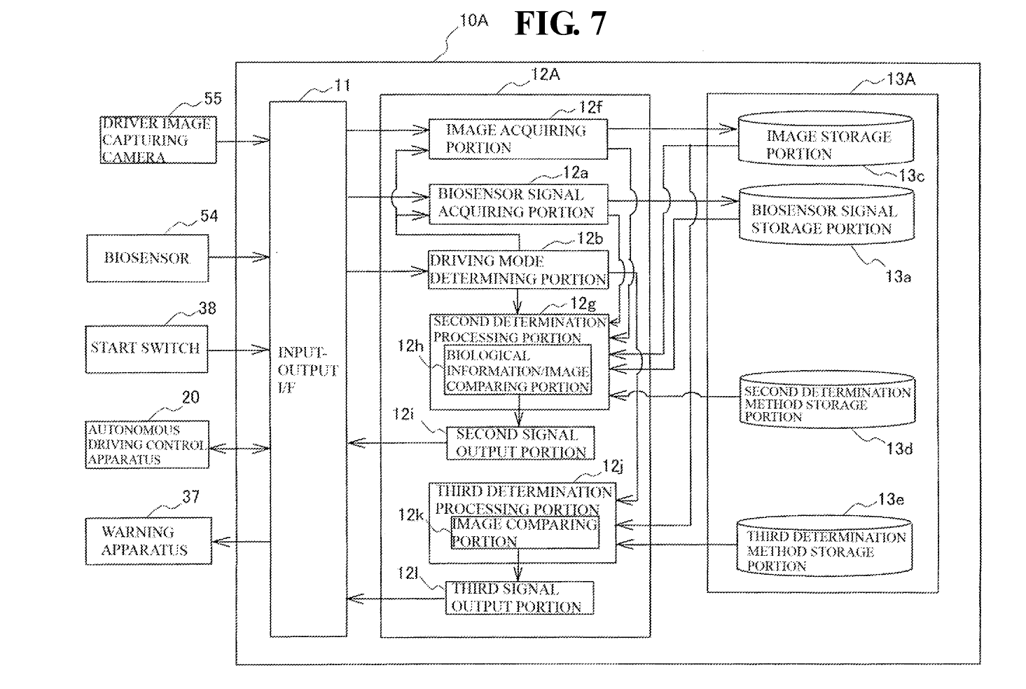

FIG. 7 is a block diagram showing a hardware configuration of the driver monitoring apparatus 10A according to Embodiment (2). Structures that have the same functions as those of the hardware configuration of the driver monitoring apparatus 10 shown in FIG. 3 are assigned the same numerals, and descriptions thereof are omitted.

The driver monitoring apparatus 10A according to Embodiment (2) is configured to include the input/output interface (I/F) 11, the control unit 12A, and the storage unit 13A.

The input-output I/F 11 is connected to the driver image capturing camera 55, the biosensor 54, the start switch 38, the autonomous driving control apparatus 20, the warning apparatus 37, and so on, and is configured to include circuits, connectors, and the like for exchanging signals with these external devices.

The control unit 12A is configured to include an image acquiring portion 12f, the biosensor signal acquiring portion 12a, the driving mode determining portion 12b, a second determination processing portion 12g, a second signal output portion 12i, a third determination processing portion 12j, and a third signal output portion 12l, and is configured to include one or more hardware processors, such as a CPU.

The storage unit 13A is configured to include an image storage portion 13c, the biosensor signal storage portion 13a, a second determination method storage portion 13d, and a third determination method storage portion 13e, and is configured to include one or more memory devices for storing data using semiconductor devices, such as a ROM, a RAM, a solid-state drive (SSD), a hard disk drive (HDD), a flash memory, and other nonvolatile memories and volatile memories.

The image storage portion 13c in the storage unit 13A stores a driver image (first driver image) that is captured by the driver image capturing camera 55 during the manual driving mode.

The biosensor signal acquiring portion 13a stores the biosensor signal (first biological information) that is acquired by the biosensor signal acquiring portion 12a during the manual driving mode.

The second determination method storage portion 13d stores a second determination processing program, which is to be executed by the second determination processing portion 12g in the control unit 12A, data required to execute this program, and the like.

The third determination method storage portion 13e stores a third determination processing program, which is to be executed by the third determination processing portion 12j in the control unit 12A, data required to execute this program, and the like.

The control unit 12A is configured to cooperate with the storage unit 13A to perform processing to store acquired data in the storage unit 13A, as well as read out data and programs stored in the storage unit 13A and execute these programs.

The driving mode determining portion 12b, which is included in the control unit 12A, executes, for example, processing to determine the driving mode, which may be the autonomous driving mode or the manual driving mode, based on an autonomous driving mode setting signal, an autonomous driving mode cancel notification signal, an autonomous driving mode cancel signal, and so on, which are acquired from the autonomous driving control apparatus 20.

If it is determined by the driving mode determining portion 12b that the current driving mode is the manual driving mode, the biosensor signal acquiring portion 12a executes processing to acquire a biosensor signal from the biosensor 54, and executes processing to store the acquired biosensor signal as a biosensor signal (first biological information) obtained during the manual driving mode, in the biosensor signal storage portion 13a.

If it is determined by the driving mode determining portion 12b that the current driving mode is the manual driving mode, the image acquiring portion 12f executes processing to acquire a driver image captured by the driver image capturing camera 55, and executes processing to store the acquired driver image as a driver image (first driver image) obtained during the manual driving mode, in the image storage portion 13c.

The driver image (first driver image) obtained during the manual driving mode is used as an image that is registered for image comparison processing, i.e. driver face authentication processing, executed by a biological information/image comparing portion 12h in the second determination processing portion 12g. The image acquiring portion 12f may also detect the face of the driver, detect a facial organ, or extract features, for example, using the driver image obtained during the manual driving mode, and store data thereabout in the image storage portion 13c.

Also, if an autonomous driving mode cancel notification (notification of switching from the autonomous driving mode to the manual driving mode) is detected by the driving mode determining portion 12b, the biosensor signal acquiring portion 12a executes processing to acquire a biosensor signal (second biological information) from the biosensor 54, and sends the acquired biosensor signal to the second determination processing portion 12g.

Also, if the autonomous driving mode cancel notification is detected by the driving mode determining portion 12b, the image acquiring portion 12f executes processing to acquire the driver image captured by the driver image capturing camera 55, and sends the acquired driver image (second driver image) to the second determination processing portion 12g.

The driver image (second driver image) obtained at the time when the autonomous driving mode cancel notification was given is used as an image to be authenticated in image comparison processing, i.e. driver face authentication processing, executed by the biological information/image comparing portion 12h in the second determination processing portion 12g. The image acquiring portion 12f may also detect the face of the driver, detect a facial organ, or extract features, for example, using the driver image obtained during the manual driving mode, and send data thereabout to the second determination processing portion 12g.

If it is determined by the driving mode determining portion 12b that the current driving mode is the autonomous driving mode, the image acquiring portion 12f executes processing to acquire the driver image captured by the driver image capturing camera 55, and sends the acquired driver image (third driver image) to the third determination processing portion 12j.

The driver image (third driver image) obtained during the autonomous driving mode is used as an image to be authenticated in image comparison processing, i.e. driver face authentication processing, executed by an image comparing portion 12k in the third determination processing portion 12j. The image acquiring portion 12f may also detect the face of the driver, detect a facial organ, or extract features, for example, using the driver image obtained during the manual driving mode, and also send data thereabout to the third determination processing portion 12j.

If an autonomous driving mode cancel notification is detected by the driving mode determining portion 12b, the biological information/image comparing portion 12h in the second determination processing portion 12g reads out the biosensor signal obtained during the manual driving mode from the biosensor signal storage portion 13a, and also reads out the driver image obtained during the manual driving mode from the image storage portion 13c. The biological information/image comparing portion 12h then executes processing to compare the read biosensor signal (first biological information) obtained during the manual driving mode with the biosensor signal (second biological information) acquired after the autonomous driving mode cancel notification has been given, and also compare the read driver image (first driver image) obtained during the manual driving mode with the driver image (second driver image) acquired after the autonomous driving mode cancel notification has been given (face authentication). Known face authentication techniques may be employed for this face authentication processing.

The second signal output portion 12i outputs a signal that is based on the result of the determination performed by the biological information/image comparing portion 12h. For example, if the comparison results from the biological information/image comparing portion 12h indicate a match, the second signal output portion 12i outputs a signal for permitting switching from the autonomous driving mode to the manual driving mode to the autonomous driving control apparatus 20. On the other hand, if the comparison result indicates no match, the second signal output portion 12i executes processing to output a signal for instructing the warning apparatus 37 to perform warning processing, or output a signal for giving a forcible danger avoidance instruction to force the vehicle to perform danger avoidance (stop or decelerate) through autonomous driving, to the autonomous driving control apparatus 20.

If it is determined by the driving mode determining portion 12b that the current driving mode is the autonomous driving mode, the image comparing portion 12k in the third determination processing portion 12j executes (face authentication) processing to read out the driver image obtained during the manual driving mode from the image storage portion 13c, and compare the read driver image (first driver image) obtained during the manual driving mode with the driver image (third driver image) obtained during the autonomous driving mode. Known face authentication techniques may be employed for this face authentication processing.

The third signal output portion 12l outputs a signal that is based on the result of the determination performed by the image comparing portion 12k. For example, if the comparison result from the image comparing portion 12k indicates a match, the third signal output portion 12l outputs a signal for continuing the autonomous driving mode as-is. On the other hand, if the comparison result indicates no match (i.e. if the driver who was driving during the manual driving mode differs from the driver during the autonomous driving mode), the third signal output portion 12l executes processing to output a signal for instructing the warning apparatus 37 to perform warning processing, or output a signal for giving a forcible danger avoidance instruction to force the vehicle to perform danger avoidance (stop or decelerate) through autonomous driving, to the autonomous driving control apparatus 20.

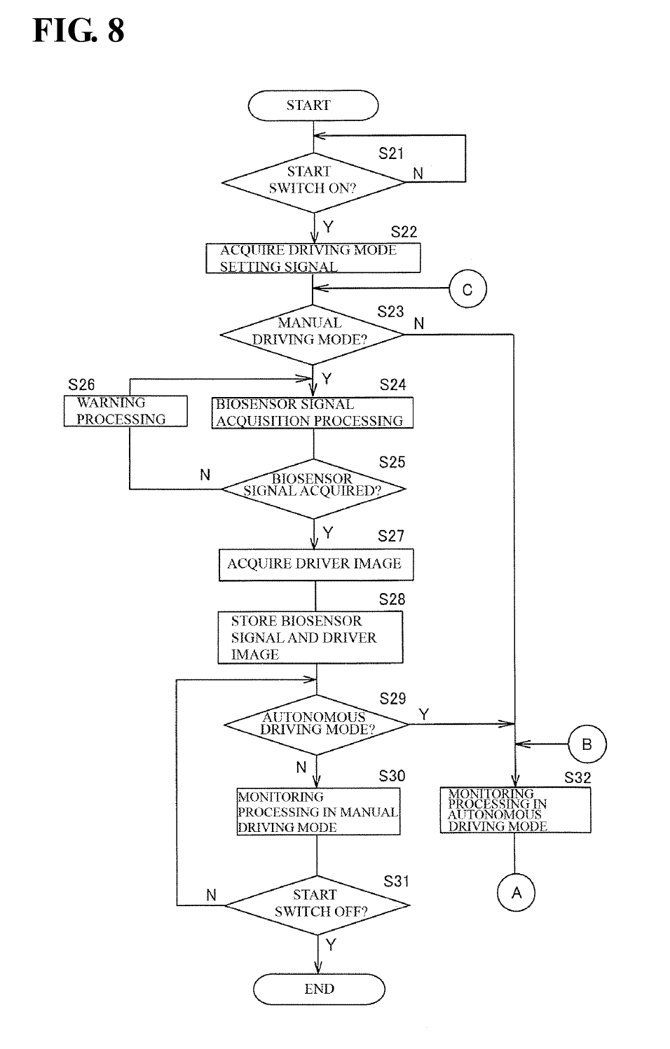

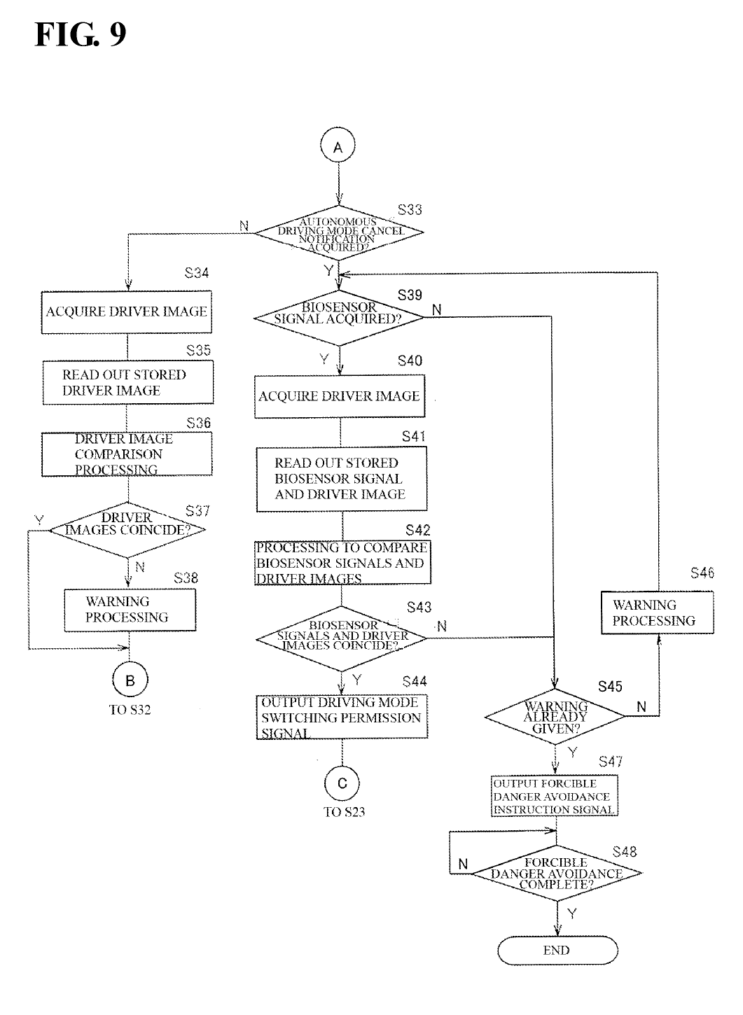

FIGS. 8 and 9 show a flowchart showing a processing operation performed by the control unit 12A in the driver monitoring apparatus 10A according to Embodiment (2).

Initially, in step S21, whether or not an ON signal from the start switch 38 has been acquired is determined. If it is determined that the ON signal from the start switch 38 has been acquired, the processing proceeds to step S22. In step S22, a driving mode setting signal for setting the autonomous driving mode or the manual driving mode is acquired from the autonomous driving control apparatus 20, and the processing then proceeds to step S23.

In step S23, whether or not the current driving mode is the manual driving mode is determined. If it is determined that the current driving mode is the manual driving mode, the processing proceeds to step S24. In step S24, processing is performed to acquire the biosensor signal (first biological information) detected by the biosensor 54, and the processing then proceeds to step S25.

In step S25, whether or not the biosensor signal (first biological information) has been acquired is determined. If it is determined that the biosensor signal has not been acquired, the processing proceeds to step S26. In step S26, a signal for instructing the warning apparatus 37 to output a warning to make the driver grip the steering wheel 52 is output, and the processing then returns to step S24. The warning apparatus 37 performs warning processing to make the driver grip the steering wheel 52, based on the warning output instruction signal from the driver monitoring apparatus 10A.

On the other hand, if it is determined in step S25 that the biosensor signal has been acquired, the processing proceeds to step S27. In step S27, processing is performed to acquire the driver image (first driver image) captured by the driver image capturing camera 55. In the next step S28, processing is performed to store the biosensor signal (first biological information) acquired during the manual driving mode and the driver image (first driver image) in the biosensor signal storage portion 13a and the image storage portion 13c, respectively. Thereafter, the processing proceeds to step S29.

In step S29, whether or not a signal for setting (switching to) the autonomous driving mode has been acquired is determined. If it is determined that the signal has not been acquired, the processing proceeds to step S30. In step S30, driver monitoring processing in the manual driving mode is performed. For example, processing is performed to capture an image of the driver who is driving manually, using the driver image capturing camera 55, and analyze the captured driver image to monitor the state of the driver.

Thereafter, in step S31, whether or not an OFF signal from the start switch 38 has been acquired is determined. If it is determined that the OFF signal has been acquired, the processing ends. On the other hand, if it is determined that the OFF signal has not been acquired, the processing returns to step S29.

On the other hand, if it is determined in step S23 that the current driving mode is not the manual driving mode, i.e. the current driving mode is the autonomous driving mode, or if it is determined in step S29 that the signal for setting the autonomous driving mode has been acquired, the processing proceeds to step S32. In step S32, driver monitoring processing in the autonomous driving mode is performed. For example, processing is performed to capture an image of the driver during autonomous driving using the driver image capturing camera 55 and analyze the captured driver image to monitor the state of the driver. The processing then proceeds to step S33 shown in FIG. 9.

In step S33, whether or not an autonomous driving mode cancel notification signal (signal for making a notification of switching to the manual driving mode) has been acquired is determined. If it is determined that the autonomous driving mode cancel notification signal has not been acquired (i.e. during the autonomous driving mode), the processing proceeds to step S34. In step S34, processing is performed to acquire the driver image (third driver image) captured by the driver image capturing camera 55.

In the next step S35, the driver image (first driver image) that was stored during the manual driving mode is read out from the image storage portion 13c. In the next step S36, (face authentication) processing is performed to compare the driver image (first drive image) obtained during the manual driving mode with the driver image (third driver image) acquired during the autonomous driving mode. The processing then proceeds to step S37.

In step S37, whether or not these driver images match each other is determined. If it is determined that the driver images match each other, i.e. the driver who was driving during the manual driving mode is the same as the driver during the autonomous driving mode, the processing returns to step S32. On the other hand, if it is determined that the drivers do not match each other, i.e. the driver who was driving during the manual driving mode differs from the driver during the autonomous driving mode, the processing proceeds to step S38. In step S38, a signal for instructing the warning apparatus 37 to warn that the driver who was driving during the manual driving mode differs from the driver during the autonomous driving mode is output. Thereafter, the processing proceeds to step S32. The warning apparatus 37 performs warning processing to make the driver who was driving during the manual driving mode drive the vehicle, based on the warning output instruction signal from the driver monitoring apparatus 10A.

On the other hand, if it is determined in step S33 that the autonomous driving mode cancel notification signal has been acquired, the processing proceeds to step S39. In step S39, whether or not the biosensor signal (second biological information) detected by the biosensor 54 has been acquired is determined. If it is determined that the biosensor signal has been acquired, the processing proceeds to step S40.

In step S40, processing is performed to acquire the driver image (second driver image) captured by the driver image capturing camera 55, and the processing then proceeds to step S41. In step S41, processing is performed to read out the biosensor signal (first biological information) and the driver image (first driver image) that were obtained during the manual driving mode from the biosensor signal storage portion 13a and the image storage portion 13c. The processing then proceeds to step S42. In step S42, processing is performed to compare the biosensor signal (second biological information) and the driver image (second driver image) that were acquired after the autonomous driving mode cancel notification was given, with the biosensor signal (first biological information) and the driver image (first driver image) that were obtained during the manual driving mode. Thereafter, the processing proceeds to step S43.

In step S43, whether or not the biosensor signals and the driver images respectively coincide with each other is determined. If it is determined that the biosensor signals and the driver images respectively coincide with each other, i.e. the driver at the time of the autonomous driving mode cancel notification (i.e. before the autonomous driving mode is switched to the manual driving mode) is the same as the driver who was driving during the manual driving mode, that is, the driver is gripping the steering wheel 52 and is ready to drive, the processing proceeds to step S44. In step S44, processing is performed to output a signal for permitting switching of the driving mode from autonomous driving to manual driving to the autonomous driving control apparatus 20, and the processing then returns to step S23. The autonomous driving control apparatus 20 performs processing to cancel the autonomous driving mode and transition to the manual driving mode based on the driving mode switching permission signal from the driver monitoring apparatus 10A.

On the other hand, if it is determined in step S39 that the biosensor signal has not been acquired from the biosensor 54, the processing proceeds to step S45. In step S45, whether or not a warning that the biosensor signal has not been acquired from the biosensor 54 has already been given (i.e. a warning has already been given) is determined. If it is determined that the warning has not been given, the processing proceeds to step S46, a signal for instructing the warning apparatus 37 to output a warning for making the driver grip the steering wheel 52 is output, and the processing returns to step S39. The warning apparatus 37 performs warning processing to make the driver grip the steering wheel 52, based on the warning output instruction signal from the driver monitoring apparatus 10A.

On the other hand, if it is determined in step S45 that the warning indicating that the biosensor signal has not been acquired from the biosensor 54 has been given (i.e. the warning has already been given), the processing proceeds to step S47. In step S47, processing is performed to output a signal for giving an instruction to perform forcible danger avoidance through autonomous driving to the autonomous driving control apparatus 20. Thereafter, in step S48, whether or not a forcible danger avoidance completion signal has been acquired from the autonomous driving control apparatus 20 is determined. If it is determined that the forcible danger avoidance completion signal has been acquired, the processing then ends.

If it is determined in step S43 that the biosensor signals and the driver images respectively coincide with each other, the processing proceeds to step S45. In step S45, whether or not a warning that the biosensor signals and the driver images do not respectively coincide with each other has already been given (i.e. a warning has already been given) is determined. If it is determined that the warning has not been given, the processing proceeds to step S46. In step S46, a signal for instructing the warning apparatus 37 to output a warning to make the driver who was driving during the manual driving mode drive the vehicle is output, and the processing then returns to step S39. The warning apparatus 37 performs warning processing to make the driver who was driving during the manual driving mode drive the vehicle, based on the warning output instruction signal from the driver monitoring apparatus 10A.

On the other hand, if it is determined in step S45 that the warning that the biosensor signals and the driver images do not respectively coincide with each other has been given (i.e. the warning has already been given), the processing proceeds to step S47. In step S47, processing is performed to output a signal for giving an instruction to perform forcible danger avoidance through autonomous driving to the autonomous driving control apparatus 20. Thereafter, in step S48, whether or not a forcible danger avoidance completion signal has been acquired from the autonomous driving control apparatus 20 is determined. If it is determined that the forcible danger avoidance completion signal has been acquired, the processing then ends.

With the driver monitoring apparatus 10A according to Embodiment (2), if the autonomous driving mode is switched to the manual driving mode (e.g. after the aforementioned autonomous driving mode cancel notification has been given), the biosensor information (second biological information) acquired by the biosensor signal acquiring portion 12a and the driver image (second driver image) acquired by the image acquiring portion 12f are compared, respectively, with the biosensor information (first biological information) obtained during the manual driving mode that is read out from the biosensor signal storage portion 13a and the driver image (first driver image) obtained during the manual driving mode that is read out from the image storage portion 13c. Thus, whether or not the driver who is to drive during manual driving is gripping the steering wheel 52 can be more accurately detected than in the above-described Embodiment (1) that does not use the driver images.

Also, with the driver monitoring apparatus 10A, whether or not the driver during the autonomous driving mode matches the driver who was driving during the manual driving mode is determined by using the third driver image that is acquired by the image acquiring portion 12f during the autonomous driving mode and the first driver image that is read out from the image storage portion 13c.

Accordingly, whether or not the driver, i.e. the person who operates the steering wheel 52 and sits in the driver seat has changed, after the manual driving mode has been switched to the autonomous driving mode (during the autonomous driving mode) can be detected. By giving a warning if the fact that the driver has changed is detected, changing of the driver during the autonomous driving mode can be prevented.

(Note 1)

A driver monitoring apparatus that monitors a driver who sits in a driver seat in a vehicle provided with an autonomous driving mode and a manual driving mode, the apparatus including:

a memory including a biological information storage portion configured to store biological information detected by a biological information detecting portion provided in a steering wheel of the vehicle; and

at least one hardware processor connected to the memory,

wherein the at least one hardware processor is configured to:

acquire first biological information detected by the biological information detecting portion during the manual driving mode;

cause the biological information storage portion to store the acquired first biological information;

acquire second biological information detected by the biological information detecting portion if the autonomous driving mode is switched to the manual driving mode;

read out the first biological information from the biological information storage portion;

determine whether or not the driver who drives during the manual driving mode is gripping the steering wheel, based on the second biological information and the first biological information; and output a signal that is based on a result of the determination.

(Note 2)

A driver monitoring method for monitoring a driver sitting in a driver seat in a vehicle provided with an autonomous driving mode and a manual driving mode, using an apparatus that includes a memory including a biological information storage portion configured to store biological information detected by a biological information detecting portion provided in a steering wheel of the vehicle, and

at least one hardware processor connected to the memory, the method including:

acquiring first biological information detected by the biological information detecting portion during the manual driving mode, by the at least one hardware processor;

causing the biological information storage portion to store the acquired first biological information, by the at least one hardware processor;

acquiring second biological information detected by the biological information detecting portion, and reading out the first biological information from the biological information storage portion, by the at least one hardware processor, if the autonomous driving mode is switched to the manual driving mode;

determining whether or not the driver who drives during the manual driving mode is gripping the steering wheel, based on the second biological information and the first biological information, by the at least one hardware processor; and

outputting a signal that is based on a result of the determination, by the at least one hardware processor.

1. A driver monitoring apparatus that monitors a driver sitting in a driver seat in a vehicle provided with an autonomous driving mode and a manual driving mode, the apparatus comprising:
a biological information acquiring portion configured to acquire biological information detected by a biological information detecting portion provided in a steering wheel of the vehicle;
a biological information storage portion configured to store first biological information acquired by the biological information acquiring portion during the manual driving mode;
a first determination processing portion configured to determine whether or not the driver who is to drive during the manual driving mode is gripping the steering wheel, based on second biological information acquired by the biological information acquiring portion and the first biological information read out from the biological information storage portion, if the autonomous driving mode is to be switched to the manual driving mode; and
a first signal output portion configured to output a predetermined signal that is based on a result of the determination performed by the first determination processing portion.

2. The driver monitoring apparatus according to claim 1, further comprising:
an image acquiring portion configured to acquire a driver image captured by an image capturing portion for capturing an image of the driver; and
an image storage portion configured to store a first driver image acquired by the image acquiring portion during the manual driving mode,
wherein the driver monitoring apparatus comprises, in place of the first determination processing portion and the first signal output portion:
a second determination processing portion configured to determine whether or not the driver who is to drive during the manual driving mode is gripping the steering wheel, based on the second biological information acquired by the biological information acquiring portion, the first biological information read out from the biological information storage portion, a second driver image acquired by the image acquiring portion, and the first driver image read out from the image storage portion, if the autonomous driving mode is to be switched to the manual driving mode; and
a second signal output portion configured to output a predetermined signal that is based on a result of the determination performed by the second determination processing portion.

3. The driver monitoring apparatus according to claim 2, further comprising:
a third determination processing portion configured to determine whether or not the driver during the autonomous driving mode matches the driver who is to drive during the manual driving mode, based on a third driver image acquired by the image acquiring portion during the autonomous driving mode, and the first driver image read out from the image storage portion; and
a third signal output portion configured to output a predetermined signal that is based on a result of the determination performed by the third determination processing portion.

4. The driver monitoring apparatus according to claim 1,
wherein, if it is determined by the first determination processing portion that the driver who is to drive during the manual driving mode is gripping the steering wheel, the first signal output portion outputs a signal for permitting switching from the autonomous driving mode to the manual driving mode, to an autonomous driving control portion that performs control in the autonomous driving mode.

5. The driver monitoring apparatus according to claim 1,
wherein, if it is determined by the first determination processing portion that the driver who is to drive during the manual driving mode is not gripping the steering wheel, the first signal output portion outputs, to a warning portion provided in the vehicle, a signal for causing the warning portion to execute predetermined warning processing.

6. The driver monitoring apparatus according to claim 1,
wherein, if it is determined by the first determination processing portion that the driver who is to drive during the manual driving mode is not gripping the steering wheel, the first signal output portion outputs a signal for giving an instruction to stop the vehicle through autonomous driving, to an autonomous driving control portion that performs control in the autonomous driving mode.

7. The driver monitoring apparatus according to claim 2,
wherein, if it is determined by the second determination processing portion that the driver who is to drive during the manual driving mode is gripping the steering wheel, the second signal output portion outputs a signal for permitting switching from the autonomous driving mode to the manual driving mode, to an autonomous driving control portion that performs control in the autonomous driving mode.

8. The driver monitoring apparatus according to claim 2,
wherein, if it is determined by the second determination processing portion that the driver who is to drive during the manual driving mode is not gripping the steering wheel, the second signal output portion outputs, to a warning portion provided in the vehicle, a signal for causing the warning portion to execute predetermined warning processing.

9. The driver monitoring apparatus according to claim 2,
wherein, if it is determined by the second determination processing portion that the driver who is to drive during the manual driving mode is not gripping the steering wheel, the second signal output portion outputs a signal for giving an instruction to stop the vehicle through autonomous driving, to an autonomous driving control portion that performs control in the autonomous driving mode.

10. A driver monitoring method for monitoring a driver sitting in a driver seat in a vehicle provided with an autonomous driving mode and a manual driving mode, by using an apparatus including a storage portion and a hardware processor connected to the storage portion,
the storage portion including a biological information storage portion configured to store biological information detected by a biological information detecting portion provided in a steering wheel of the vehicle,
the method comprising:
acquiring first biological information detected by the biological information detecting portion during the manual driving mode, by the hardware processor;
causing the biological information storage portion to store the acquired first biological information, by the hardware processor;
acquiring second biological information detected by the biological information detecting portion, by the hardware processor, if the autonomous driving mode is to be switched to the manual driving mode;
reading out the first biological information from the biological information storage portion, by the hardware processor;
determining whether or not the driver who is to drive during the manual driving mode is gripping the steering wheel, based on the second biological information and the first biological information, by the hardware processor; and
outputting a predetermined signal that is based on a result of the determination, by the hardware processor.

11. The driver monitoring apparatus according to claim 3,
wherein, if it is determined by the second determination processing portion that the driver who is to drive during the manual driving mode is gripping the steering wheel, the second signal output portion outputs a signal for permitting switching from the autonomous driving mode to the manual driving mode, to an autonomous driving control portion that performs control in the autonomous driving mode.

12. The driver monitoring apparatus according to claim 3,
wherein, if it is determined by the second determination processing portion that the driver who is to drive during the manual driving mode is not gripping the steering wheel, the second signal output portion outputs, to a warning portion provided in the vehicle, a signal for causing the warning portion to execute predetermined warning processing.

13. The driver monitoring apparatus according to claim 3,
wherein, if it is determined by the second determination processing portion that the driver who is to drive during the manual driving mode is not gripping the steering wheel, the second signal output portion outputs a signal for giving an instruction to stop the vehicle through autonomous driving, to an autonomous driving control portion that performs control in the autonomous driving mode.
